(19) United States
(12) Patent Application Publication
(10) Pub. No.: US 2011/0296176 A1
(43) Pub. Date: Dec. 1, 2011

(54) METHOD AND SYSTEM FOR SHARING DATA

(75) Inventors: Mafruzzaman Ashrafi, Singapore (SG); See Kiong Ng, Singapore (SG)

(73) Assignee: AGENCY FOR SCIENCE, TECHNOLOGY AND RESEARCH, Singapore (SG)

(21) Appl. No.: 12/994,747

(22) PCT Filed: May 27, 2009
(86) PCT No.: PCT/SG2009/000186

§ 371 Date: Aug. 15, 2011

Related U.S. Application Data
(60) Provisional application No. 61/056,190, filed on May 27, 2008.

(51) Int. Cl. H04L 9/00

(52) U.S. Cl. 713/167

(57) ABSTRACT

A method of sharing data between a first and a second party, a system for sharing data between a first and a second party and a computer readable data storage medium having stored thereon computer code means for instructing respective computer processors of a first party and a second party to execute a method of sharing data between the first and the second parties are provided. The method comprises the steps of performing respective randomization processes on data sets of the first and second parties; performing an exchange process between the first and second parties; performing an audit trail check process at the first and second parties respectively; and proceeding with performing a matching process at the first and second parties respectively only after a successful audit trail check by each party in the audit trail check process and the matching process is such that each party can determine whether the other party has provided a correct re-obfuscating number for determining common records between the first and second party.

### FIELD OF INVENTION

The present invention relates broadly to a method of sharing data between a first and a second party, to a system for sharing data between a first and a second party and to a computer readable data storage medium having stored thereon computer code means for instructing respective computer processors of a first party and a second party to execute a method of sharing data between the first and the second parties.

### BACKGROUND

Sharing proprietary information across private databases belonging to autonomous or independent parties can be essential for decision making applications. For example, two or more countries may wish to share information of terrorist suspects. However, it is typically not feasible for one country to share the information of all its terrorist suspects with another. It is typically desired to find out the common suspects that both countries/parties are monitoring before sharing information about these suspects. In other words, one step for privacy-preserving information sharing is to allow queries to be executed across databases belonging to autonomous parties/entities to find out what records are to be shared in such a way that no other records are revealed, other than what is common among the parties/participants.

To maintain the privacy and secrecy of the databases, each of the participants encrypts its respective private dataset and then exchange the corresponding encrypted dataset/database with another party. Typically, the participating parties involved in privacy preserving information sharing protocols use commutative encryption that executes a set of instructions. Due to underlying characteristics of commutative encryption, none of the parties can sense any individual transactions or records unless these transactions are common in both databases.

It is noted that the instructions in commutative encryption are tightly coupled, meaning that the instructions are executed in ordered sequences. If the exact order is not followed, it is typically technically impossible to find the resultant intersection set. Such a technical limitation typically compels every participating party to execute the instructions/protocol in exactly the same sequence without knowing whether the other party follows it or not. Such a protocol can work with a so-called honest-but-curious setting where it is assumed that every party follows the protocol. As none of the participants is able to verify whether the other party has fully followed the protocol or not, it is possible for a particular participating party/site to find the resultant set without letting the other party know the common transactions in their respective private databases.

Provided below is a brief description of a typical information sharing process between two sites.

Assume that there are two sites S and R that have datasets D_{S} and D_{R} respectively. At a first step, both sites S and R apply a hash function h to their private datasets respectively, i.e. D′_{S}[i]=h(D_{S}[i]) and D′_{R}[j]=h(D_{R}[j]), and then randomly choose a secret key, ie. e_{S} for site S and e_{R} for site R. Site S then uses its secret key e_{S} on the hashed dataset and generates its encrypted dataset D″_{S}[i]=f_{φ}(D′_{S}[i],e_{S}), where f is a commutative encryption function defined as f_{φ}(x,e)=x^{e} mod φ. Similarly, site R generates its encrypted dataset D″_{R}. Next, to carry out the actual intersection i.e. to find out the common elements, either site S or R sends its encrypted dataset to the other site. Assume that it is site S that transmits its encrypted dataset D″_{S} to R. Upon receiving D″_{S}, site R carries out two distinct tasks. Firstly, site R uses its secret key e_{R} to encrypt each entry dεD″_{S} of D″_{S} such that D̅_̅{̅S̅}̅[i]=f_{φ}(D_{S}″[i],e_{R}). Site R then sends a pair <D″_{S}, D̅_{S}> to site S and then sends its own encrypted set D″_{R} to site S. Upon receiving D″_{R}, site S encrypts each entry dεD″_{R} of D″_{R} with secret key e_{S} such that D̅_̅{̅R̅}̅[j]=f_{φ}(D_{R}″[j],e_{S}). Since at this stage, site S possesses the two sets that are D̅_{S} and D̅_{R}, site S is able to intersect all common elements between D_{S} and D_{R}. Although site S can already obtain a resultant intersection set at this stage, site R does not have any knowledge about the common elements. In order to discover the resultant intersection set, site R is totally reliant upon site S. In fact, it is possible to have a scenario whereby site S manipulates or deliberately misleads site R about the resultant intersection set, such that the benefits of mutual information sharing is only attained by site S. Furthermore, even if site R enforces site S to send the pair <D″_{R}, D̅_{R}> to it, site S can still mislead site R if S encrypts each entry dεD″_{R} of D″_{R} with another secret number e_{W} such that e_{S}≠e_{W}. If S uses a different secret number and sends the encrypted set back to R, one disadvantage is that R would not be able to tell that S is dishonest. In other words, R would simply have no intersection of entries (due to the different secret number used by S) and would arrive at a conclusion that there are no common elements with S. Indeed, such a scenario typically raises a critical question about the usefulness of information sharing. That is, unless all participating sites achieve the same foreseeable benefits where none of the sites are able to mislead each other, typical distrusting parties would not be willing to share their data.

Hence, there exists a need for a method of sharing data between a first and a second party, a system for sharing data between a first and a second party and a computer readable data storage medium having stored thereon computer code means for instructing respective computer processors of a first party and a second party to execute a method of sharing data between the first and the second parties that seek to address at least one of the above problems.

### SUMMARY

In accordance with a first aspect of the present invention, there is provided a method of sharing data between a first and a second party, the method comprising the steps of: performing respective randomization processes on data sets of the first and second parties; performing an exchange process between the first and second parties; performing an audit trail check process at the first and second parties respectively; and proceeding with performing a matching process at the first and second parties respectively only after a successful audit trail check by each party in the audit trail check process and the matching process is such that each party can determine whether the other party has provided a correct re-obfuscating number for determining common records between the first and second party.

The respective randomization processes may comprise obfuscating the data sets using respective obfuscating numbers of the first and second parties; concatenating the obfuscated data sets with respective audit trail elements of the first and second parties; and randomly shuffling the concatenated data sets of the first and second parties.

The method may further comprise, prior to the obfuscating step, the steps of: hashing the data sets of the first and second parties; and encrypting the hashed data sets of the first and second parties.

The exchange process may comprise exchanging the randomly shuffled data sets between the first and second parties; re-encrypting the exchanged randomly shuffled data sets at the first and second parties respectively; re-obfuscating the re-encrypted data sets using the respective re-obfuscating numbers at the first and second parties; and exchanging the re-obfuscated data sets between the first and second parties.

The exchange process may further comprise generating respective temporary numbers at the first and second parties; exchanging the temporary numbers between the first and second parties; encrypting the exchanged temporary numbers at the first and second parties respectively; and wherein the re-obfuscating step is based on the encrypted temporary numbers and the respective obfuscating numbers of the first and second parties.

The audit trail check process may comprise sharing respective encrypted common trail generators between the first and second parties; sharing respective modulo function values based on the encrypted temporary numbers and the obfuscating numbers between the first and second parties; computing respective re-obfuscated audit trail sets at the first and second parties based on the shared encrypted common trail generators and modulo function values; and performing the respective audit trail checks at the first and second parties based on the re-obfuscated audit trail sets and the re-obfuscated data sets.

The matching process may comprise sharing the respective re-obfuscating numbers between the first and second parties; verifying the respective shared re-obfuscating numbers at the first and second parties respectively; re-generating the other party's re-obfuscated data set at the first and second parties respectively based on the verified re-obfuscating numbers; and determining the common records between the first and second party based on intersecting the re-generated re-obfuscated data set of the other party with the party's own re-obfuscated data set.

In accordance with a second aspect of the present invention, there is provided a system for sharing data between a first and a second party, the system comprising means for performing respective randomization processes on data sets of the first and second parties; means for performing an exchange process between the first and second parties; means for performing an audit trail check process at the first and second parties respectively; and means for proceeding with performing a matching process at the first and second parties respectively only after a successful audit trail check by each party in the audit trail check process and the matching process is such that each party can determine whether the other party has provided a correct re-obfuscating number for determining common records between the first and second party.

The means for performing respective randomization processes may be arranged to obfuscate the data sets using respective obfuscating numbers of the first and second parties; concatenate the obfuscated data sets with respective audit trail elements of the first and second parties; and randomly shuffle the concatenated data sets of the first and second parties.

The means for performing respective randomization processes may be further arranged to hash the data sets of the first and second parties; and encrypt the hashed data sets of the first and second parties.

The means for performing an exchange process may be arranged to exchange the randomly shuffled data sets between the first and second parties; re-encrypt the exchanged randomly shuffled data sets at the first and second parties respectively; re-obfuscate the re-encrypted data sets using the respective re-obfuscating numbers at the first and second parties; and exchange the re-obfuscated data sets between the first and second parties.

The means for performing an exchange process may be further arranged to generate respective temporary numbers at the first and second parties; exchange the temporary numbers between the first and second parties; encrypt the exchanged temporary numbers at the first and second parties respectively; and wherein the re-obfuscation of the re-encrypted data sets is based on the encrypted temporary numbers and the respective obfuscating numbers of the first and second parties.

The means for performing an audit trail check process may be arranged to share respective encrypted common trail generators between the first and second parties; share respective modulo function values based on the encrypted temporary numbers and the obfuscating numbers between the first and second parties; compute respective re-obfuscated audit trail sets at the first and second parties based on the shared encrypted common trail generators and modulo function values; and perform the respective audit trail checks at the first and second parties based on the re-obfuscated audit trail sets and the re-obfuscated data sets.

The means for proceeding with performing a matching process may be arranged to share the respective re-obfuscating numbers between the first and second parties; verify the respective shared re-obfuscating numbers at the first and second parties respectively; re-generate the other party's re-obfuscated data set at the first and second parties respectively based on the verified re-obfuscating numbers; and determine the common records between the first and second party based on intersecting the re-generated re-obfuscated data set of the other party with the party's own re-obfuscated data set.

In accordance with a third aspect of the present invention, there is provided a computer readable data storage medium having stored thereon computer code means for instructing respective computer processors of a first party and a second party to execute a method of sharing data between the first and the second parties, the method comprising the steps of: performing respective randomization processes on data sets of the first and second parties; performing an exchange process between the first and second parties; performing an audit trail check process at the first and second parties respectively; and proceeding with performing a matching process at the first and second parties respectively only after a successful audit trail check by each party in the audit trail check process and the matching process is such that each party can determine whether the other party has provided a correct re-obfuscating number for determining common records between the first and second party.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a schematic diagram illustrating a data matching protocol in an example embodiment.

FIG. 2 is a schematic flowchart illustrating a method of sharing data between a first and a second party in an example embodiment

FIG. 3 is a schematic diagram illustrating a system for sharing data between system components of a first party and system components of a second party in an example embodiment.

FIG. 4 is a schematic diagram illustrating a computer system for implementing an example embodiment.

### DETAILED DESCRIPTION

In an example embodiment, a method is provided for detecting whether a participant employs hidden manipulation when executing a protocol. The example embodiment can provide a capability to audit a full execution history without the need to use a trusted third party to identify if any manipulation has occurred during the course of the protocol. Thus, the example embodiment can allow a honest party to restrict other participants from obtaining any resultant intersection set if an audit trial fails.

The method of the example embodiment combines multiple distributed datasets in a privacy-preserving manner whereby each of the participating data sites match or intersect its respective dataset with the other datasets without revealing any records other than the resultant intersection set.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

The example embodiment provides a data matching protocol that has four distinct phases: (i) randomization, (ii) exchange, (iii) audit, and (iv) matching.

During the first phase (i.e. randomization), each of the data sharing participants locally generates an encrypted dataset randomly shuffled with an audit trail set. In the second phase (i.e. exchange), the participants exchange their respective encrypted datasets and other pertinent information (such as temporary numbers, temporary secrets, encrypted obfuscated numbers and their respective re-encrypted results) with each other. In the third phase (i.e. audit), each of the participants evaluates the honesty of the other participants using the information that they have received from the other participants. If the audit phase is successful for all participants, each participant then computes the resultant intersection sets in the final phase (i.e. matching).

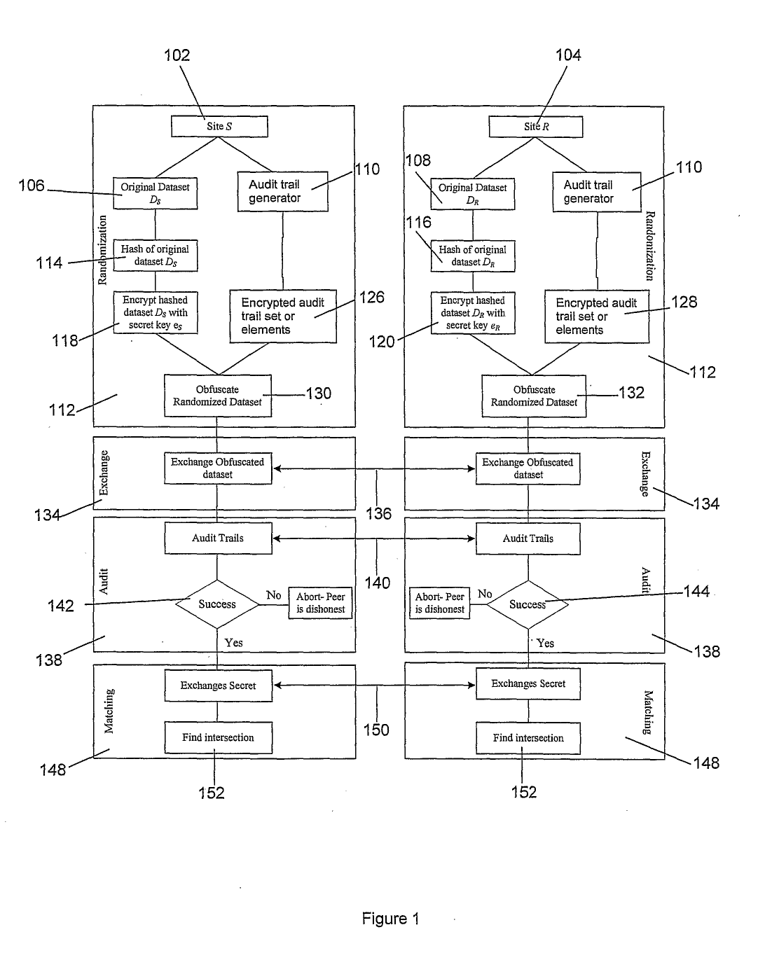

FIG. 1 is a schematic diagram illustrating a data matching protocol in one example embodiment.

Denote S 102 and R 104 as two participating sites that have datasets D_{S} 106 and D_{R} 108 of sizes n_{S} and n_{R} respectively. Before initiating the protocol, both sites S 102 and R 104 agree on using the following: a common audit trail generator ρ, 110 which is a unique value that does not exist in D_{S} 106 and D_{R} 108, a hash function h for hashing the data in the datasets D_{S} 106 and D_{R} 108, and a relatively large prime number as a public key φ. φ is defined to be the set of prime numbers in

$$[ 2 , \frac{( ϕ - 1 )}{2} ] ,$$

f is defined as a commutative encryption function such that f_{φ}(x,e)=x^{e} mod φ, and g is defined as a modulo function such that g_{φ}(x)=x mod φ. The auditable privacy-preserving data matching protocol of the example embodiment is described below.

At a first phase or a randomization phase/process 112, both site S 102 and site R 104 apply the hash function h to create hashed datasets D′_{S} 114 and D′_{R} 116 such that

D′_{S}[i]=h(D_{S}[i]), 1≦i≦n_{S} (1)

D′_{R}[j]=h(D_{R}[j]), 1≦j≦n_{R} (2)

Each site S 102 and R 104 randomly chooses a secret key, i.e. e_{S}εΦ for site S 102 and e_{R}εΦ for site R 104. Both sites S 102 and R 104 then encrypt their respective hashed datasets using their respective secret keys to obtain encrypted datasets D″_{S} (see 118) and D″_{R} (see 120) such that

D″_{S}[i]=f_{φ}(D′_{S}[i],e_{S}) (3)

D″_{R}[j]=f_{φ}(D″_{R}[j],e_{R}) (4)

Each site S 102 and R 104 then generates a relatively large prime number z_{S}<φ|z_{S}≠e_{S} for site S 102 and z_{R}<φ|z_{R}≠e_{R} for site R 104 to obtain obfuscated sets D̅_{S} and D̅_{R} as follows:

D̅_{S}[i]=g_{φ}(D″_{S}[i]×z_{S}), 1≦i≦n_{S} (5)

D̅_{R}[j]=g_{φ}(D″_{R}[j]×z_{R}), 1≦j≦n_{R} (6)

The numbers Z_{S} for site S 102 and z_{R} for site R 104 are known as respective obfuscating numbers.

Each site S 102 and R 104 also randomly chooses a set of audit trail secret keys, i.e. E_{S} for site S 102 and E_{R} for site R 104, where E_{S}⊂Φ and E_{R}⊂Φ. Denote k_{S}=|E_{S}| and k_{R}=|E_{R}|, and E_{S}={e₁, . . . , eₖ_{_{S}}), E_{R}={e₁, . . . , eₖ_{_{R}}). Each site S 102 and R 104 then computes an encrypted audit trail set or audit trail elements using the common trail generator ρ, ie. A_{S} 126 for site S 102 and A_{R}128 for site R 104, as follows:

A_{S}[i]=f_{φ}(ρ,eᵢ), 1≦i≦k_{S} (7)

A_{R}[j]=f_{φ}(ρ,eⱼ), 1≦j≦k_{R} (8)

It will be appreciated that, as the common audit trail generator ρ 110 is a unique value that does not exist in D_{S} 106 and D_{R} 108, the elements of A_{S} 126 and A_{R}128 are elements not found in the datasets D_{S} 106 and D_{R} 108.

Each site S 102 and R 104 concatenates its respective obfuscated set (see eqns (5) and (6)) with its corresponding encrypted audit trail set (see eqns (7) and (8)) to generate a set P_{S} for site S 102 and a set P_{R} for site R 104 as follows:

P_{S}= D̅_{S}⊕A_{S}=( D̅_{S}[1], . . . , D̅_{S}[n_{S}],A_{S}[1], . . . , A_{S}[k_{S}]) (9)

P_{R}= D̅_{R}⊕A_{R}=( D̅_{R}[1], . . . , D̅_{R}[n_{R}],A_{R}[1], . . . , A_{R}[k_{R}]) (10)

Each site S 102 and R 104 then creates respective randomly shuffled obfuscated sets P′_{S} (see 130) and P′_{R} (see 132) as follows:

P′_{S}[i]=g_{φ}(P_{S}[π_{S}(i)]), 1≦i≦n_{S}+k_{S} (11)

P′_{R}[j]=g_{φ}(P_{R}[π_{R}(j)]), 1≦j≦n_{R}+k_{R} (12)

where π_{S} and π_{R} are random shuffling functions for the respective sites S 102 and R 104.

At a second phase or an Exchange phase/process 134, site S 102 sends P′_{S} to site R 104 and site R 104 in turn sends P′_{R} to site S102 (see 136). Each site S 102 and R 104 uses its respective secret key e_{S}, e_{R} to re-encrypt the received obfuscated set, e.g. eqn (11) and eqn (12), that it has received from the other site S 102 and R 104. In other words, site S 102 computes

P″_{R}[j]=f_{φ}(P′_{R}[j],e_{S}) (13)

and site R 104 computes

P″_{S}[i]=f_{φ}(P′_{S}[i],e_{R}) (14)

Site S 102 generates a relatively large temporary number w_{S}<φ|w_{S}≠e_{S}, computes

w′_{S}=f_{φ}(w_{S},e_{S}) (15)

and sends [symbol] w_{S},w′_{S} [symbol] to site R 104.

Similarly, site R 104 generates a large temporary number w_{R}<φ|w_{R}≠e_{R}, computes

w′_{R}=f_{φ}(w_{R},e_{R}) (16)

and sends [symbol] w_{R},w′_{R} [symbol] to site S 102.

Each site S 102 and R 104 then re-encrypts the respective received temporary secret, ie. for site S 102,

w″_{R}=f_{φ}(w′_{R},e_{S}) (17)

and for site R 104,

w″_{S}=f_{φ}(w′_{S},e_{R}) (18)

The sites S 102 and R 104 each holds the respective re-encrypted temporary secret w″_{R} and w″_{S} for future use. It will be appreciated that the numbers w_{S} and w_{R} are not secret. However, the results in the re-encrypted values (see eqns (17 and (18)) are secret. For example, w″_{R} is secret to site R 104 and w″_{S} is secret to site S 102.

Site S 102 encrypts the prime number/obfuscating number z_{S} using secret key e_{S}, that is,

z″_{S}=f_{φ}(z_{S},e_{S}) (19)

and sends z′_{S} to site R 104. Similarly, site R 104 encrypts the prime number/obfuscating number z_{R} using secret key e_{R}, that is,

z′_{R}=f_{φ}(Z_{R},e_{R}) (20)

and sends z′_{R} to site S 102.

Site S 102 then computes

z″_{R}=g_{φ}(f_{φ}(z′_{R},e_{S})×w″_{R}) (21)

and site R104 computes

z″_{S}=g_{φ}(f_{φ}(z′_{S},e_{R})×w″_{S}) (22)

Site S102 then sends z″_{R} to site R 104 and site R 104 sends z″_{S} to site S 102.

Upon receiving z″_{S} from site R 104, site S 102 strips off one layer of encryption from z″_{S} and computes,

z̅_{S}=g_{φ}(f_{φ}⁻¹(z″_{S},e_{S})×f_{φ}(w_{R},e_{S})) (23)

Similarly, site R 104 computes

z̅_{R}=g_{φ}(f_{φ}⁻¹(z″_{R},e_{R})×f_{φ}(w_{S},e_{R})) (24)

Each site S 102 and R 104 generates another relatively large number/secret, ie. x_{S}<φ|x_{S}≠e_{S} for site S 102 and x_{R}<φ|x_{R}≠e_{R} for site R 104. The numbers x_{S} for site S 102 and x_{R} for site R 104 are known as respective re-obfuscating numbers. Each site S 102 and R 104 computes a new re-obfuscated hashed set as follows:

P̅″_{R}[j]=h(g_{φ}(P″_{R}[j]× z̅_{S}×x_{S})) (25)

for site S 102 and

P̅″_{S}[i]=h(g_{φ}(P″_{S}[i]× z̅_{R}×x_{R} (26)

for site R 104.

Site S 102 then sends P̅″_{R} to site R 104 and site R 104 sends P̅″_{S} to site S 102.

At a third phase or an Audit phase/audit trail check process 138, site S 102 computes

ρ_{S}=f_{φ}(ρ,e_{S}) (27)

t_{S}=g_{φ}( z̅_{S}×x_{S}) (28)

and site R 104 computes

ρ_{R}=f_{φ}(ρ,e_{R}) (29)

t_{R}=g_{φ}( z̅_{R}×x_{R}) (30)

Site S 102 then shares/sends [symbol] t_{S},ρ_{S} [symbol] to site R 104 and site R 104 shares/sends [symbol] t_{R},ρ_{R} [symbol] to site S 102 (see numeral 140).

Upon receiving [symbol] t_{R},ρ_{R} [symbol] from site R 104, site S 102 computes a re-obfuscated hashed audit trail set Ω_{S} as follows:

Ω_{S}[i]=h(g_{φ}(t_{R}×f_{φ}(ρ_{R},eᵢ))), 1≦i≦k_{S} (31)

Similarly, site R 104 computes Ω_{R}:

Ω_{R}[j]=h(g_{φ}(t_{S}×f_{φ}(ρ_{S},eⱼ))), 1≦j≦k_{R} (32)

Site S 102 attempts to recover the re-obfuscated hashed audit trail set (see numeral 142) from the re-obfuscated hashed data set P̅″_{S} as follows:

Ψ_{S}[i]= P̅″_{S}[π_{S}⁻¹(n_{S}+i)], 1≦i≦k_{S} (33)

That is, the elements of the dataset D_{S} are not considered and the hashed audit trail set is recovered. See the number of elements (n_{S} i) for 1≦i≦k_{S} in equation (33).

If site R 104 had executed the protocol honestly during the exchange phase 134, then site S 102 obtains Ψ_{S}=Ω_{S}.

Similarly, site R 104 verifies the honesty of site S 102 (see numeral 144) by computing:

Ψ_{R}[j]= P̅″_{R}[π_{R}⁻¹(n_{R}+j)], 1≦j≦k_{R} (34)

and then checking whether Ψ_{R}=Ω_{R} or not.

At a fourth phase or a matching phase/process 148, only if both site S 102 and R 104 have succeeded in the audit trail checks of the audit phase 138, then the sites S 102 and R 104 transmit/share their respective random numbers/re-obfuscating numbers x_{S} and x_{R} generated during the exchange phase 134 to each other (see numeral 150).

Site S 102 verifies the integrity of x_{R} as follows:

(i) v_{S1}=f_{φ}⁻¹(g_{φ}(t_{R}×f_{φ}(x_{R},e_{S}−1)),e_{S}) (35)

(ii) v_{S2}=g_{φ}(f_{φ}⁻¹((t_{S}/(x_{R})),e_{S})×x_{R}) (36)

It is noted that, based on the principle of x×x^{e}^{ₛ₋₁}=x^{e}^{ₛ}, e_{S}−1 is derived for verification of equation (35). If site R 104 sends the correct x_{R}, then site S 104 obtains v_{S1}=v_{S2}.

Similarly, site R 104 verifies the integrity of x_{S} as

v_{R1}=f_{φ}⁻¹(g_{φ}(t_{S}×f_{φ}(x_{S},e_{R}−1)),e_{R}) (37)

v_{R2}=g_{φ}(f_{φ}⁻¹((t_{R}/(x_{S})),e_{R})×x_{S}) (38)

After verifying the integrity of x_{R}, site S 102 applies z̅_{S} and x_{R} to P″_{R} and re-generates a re-obfuscated hashed set of site R 104:

\hat{D}_{S}[j]=h(g_{φ}(P″_{R}[j]× z̅_{S}×x_{R})), 1≦j≦| P̅″_{R}| (39)

Finally, site S 102 intersects set \hat{D}_{S} and P̅″_{S} to find all common records between datasets D_{S} and D_{R}, (see numeral 152), namely,

{D_{S}[π_{S}⁻¹(i)]| P̅″_{S}[i]=\hat{D}_{S}[j]} (40)

In the same manner, site R 104 finds the corresponding intersection set (see numeral 152) using the following equations:

D̅_{R}[i]=h(g_{φ}(P″_{S}[i]× z̅_{R}×x_{S})), 1≦i≦| P̅″_{S}| (41)

{D_{R}[π_{R}⁻¹(j)]| P̅″_{R}[j]=\hat{D}_{R}[i]} (42)

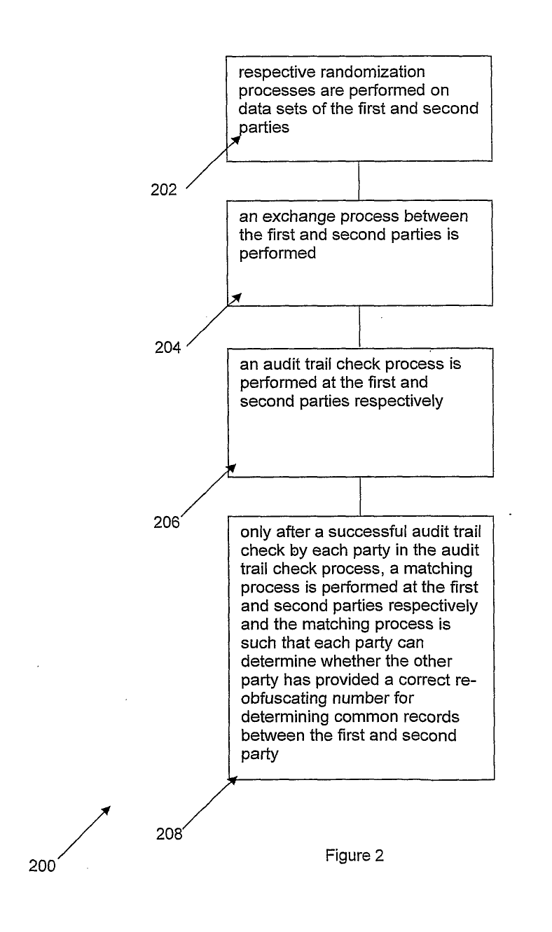

FIG. 2 is a schematic flowchart 200 illustrating a method of sharing data between a first and a second party in an example embodiment. At step 202, respective randomization processes are performed on data sets of the first and second parties. At step 204, an exchange process between the first and second parties is performed. At step 206, an audit trail check process is performed at the first and second parties respectively. At step 208, only after a successful audit trail check by each party in the audit trail check process, a matching process is performed at the first and second parties respectively and the matching process is such that each party can determine whether the other party has provided a correct re-obfuscating number for determining common records between the first and second party.

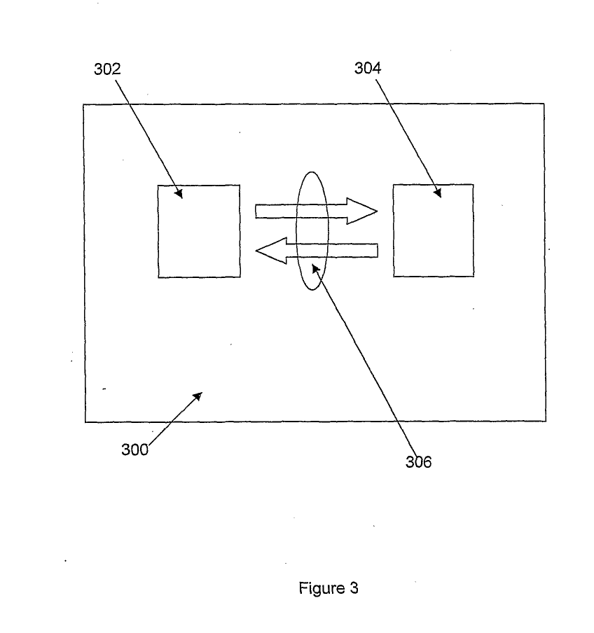

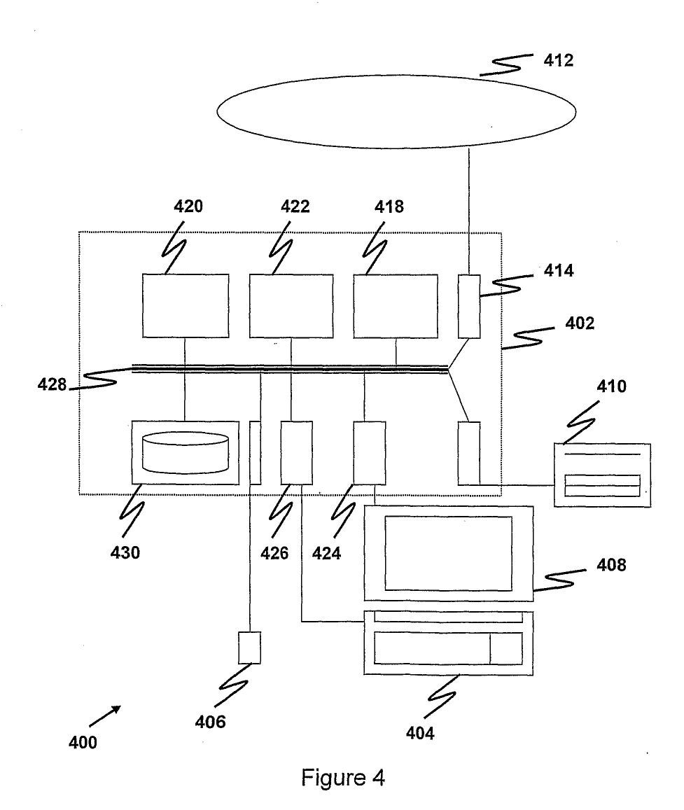

FIG. 3 is a schematic diagram illustrating a system 300 for sharing data between system components 302 of a first party and system components 304 of a second party in an example embodiment. The system 300 implements and enables the processing and exchange of data between the parties (generally indicated at numeral 306), for example, as described above with reference to FIGS. 1 and 2. It will be appreciated that each of the components 302, 304 may be components of a computer system as described below. For example, each component can be implemented using a computer system 400 (schematically shown in FIG. 4). It may be implemented as software, such as a computer program being executed within the computer system 400, and instructing the computer system 400 to conduct the method of the example embodiment.

The computer system 400 comprises a computer module 402, input modules such as a keyboard 404 and mouse 406 and a plurality of output devices such as a display 408, and printer 410.

The computer module 402 is connected to a computer network 412 via a suitable transceiver device 414, to enable access to e.g. the Internet or other network systems such as Local Area Network (LAN) or Wide Area Network (WAN).

The computer module 402 in the example includes a processor 418, a Random Access Memory (RAM) 420 and a Read Only Memory (ROM) 422. The computer module 402 also includes a number of Input/Output (I/O) interfaces, for example I/O interface 424 to the display 408, and I/O interface 426 to the keyboard 404.

The components of the computer module 402 typically communicate via an interconnected bus 428 and in a manner known to the person skilled in the relevant art.

The application program is typically supplied to the user of the computer system 400 encoded on a data storage medium such as a CD-ROM or flash memory carrier and read utilising a corresponding data storage medium drive of a data storage device 430. The application program is read and controlled in its execution by the processor 418. Intermediate storage of program data maybe accomplished using RAM 420.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, example embodiments are not limited to two communicating parties and can include a scenario where the number of participants are more than two. For example, if there are n parties, the communication overhead is up to n² because each party communicates with all other parties. With n parties, FIG. 3 can be modified to comprise n system components. Further, the inventors recognise that the communication cost can be reduced if architecture such as Binary tree network topology, etc is used.

1. A method of sharing data between a first and a second party, the method comprising the steps of:
performing respective randomization processes on data sets of the first and second parties;
performing an exchange process between the first and second parties;
performing an audit trail check process at the first and second parties respectively; and
proceeding with performing a matching process at the first and second parties respectively only after a successful audit trail check by each party in the audit trail check process and the matching process is such that each party can determine whether the other party has provided a correct re-obfuscating number for determining common records between the first and second party.

2. The method as claimed in claim 1, wherein the respective randomization processes comprise,
obfuscating the data sets using respective obfuscating numbers of the first and second parties;
concatenating the obfuscated data sets with respective audit trail elements of the first and second parties; and
randomly shuffling the concatenated data sets of the first and second parties.

3. The method as claimed in claim 2, further comprising, prior to the obfuscating step, the steps of:
hashing the data sets of the first and second parties; and
encrypting the hashed data sets of the first and second parties.

4. The method as claimed in claim 2, wherein the exchange process comprises,
exchanging the randomly shuffled data sets between the first and second parties;
re-encrypting the exchanged randomly shuffled data sets at the first and second parties respectively;
re-obfuscating the re-encrypted data sets using the respective re-obfuscating numbers at the first and second parties; and
exchanging the re-obfuscated data sets between the first and second parties.

5. The method as claimed in claim 4, wherein the exchange process further comprises,
generating respective temporary numbers at the first and second parties;
exchanging the temporary numbers between the first and second parties;
encrypting the exchanged temporary numbers at the first and second parties respectively; and
wherein the re-obfuscating step is based on the encrypted temporary numbers and the respective obfuscating numbers of the first and second parties.

6. The method as claimed in claim 5, wherein the audit trail check process comprises,
sharing respective encrypted common trail generators between the first and second parties;
sharing respective modulo function values based on the encrypted temporary numbers and the obfuscating numbers between the first and second parties;
computing respective re-obfuscated audit trail sets at the first and second parties based on the shared encrypted common trail generators and modulo function values; and
performing the respective audit trail checks at the first and second parties based on the re-obfuscated audit trail sets and the re-obfuscated data sets.

7. The method as claimed in claim 2, wherein the matching process comprises,
sharing the respective re-obfuscating numbers between the first and second parties;
verifying the respective shared re-obfuscating numbers at the first and second parties respectively;
re-generating the other party's re-obfuscated data set at the first and second parties respectively based on the verified re-obfuscating numbers; and
determining the common records between the first and second party based on intersecting the re-generated re-obfuscated data set of the other party with the party's own re-obfuscated data set.

8. A system for sharing data between a first and a second party, the system comprising,
means for performing respective randomization processes on data sets of the first and second parties;
means for performing an exchange process between the first and second parties;
means for performing an audit trail check process at the first and second parties respectively; and
means for proceeding with performing a matching process at the first and second parties respectively only after a successful audit trail check by each party in the audit trail check process and the matching process is such that each party can determine whether the other party has provided a correct re-obfuscating number for determining common records between the first and second party.

9. The system as claimed in claim 8, wherein the means for performing respective randomization processes are arranged to,
obfuscate the data sets using respective obfuscating numbers of the first and second parties;
concatenate the obfuscated data sets with respective audit trail elements of the first and second parties; and
randomly shuffle the concatenated data sets of the first and second parties.

10. The system as claimed in claim 9, wherein the means for performing respective randomization processes are further arranged to,
hash the data sets of the first and second parties; and
encrypt the hashed data sets of the first and second parties.

11. The system as claimed in claim 9, wherein the means for performing an exchange process are arranged to,
exchange the randomly shuffled data sets between the first and second parties;
re-encrypt the exchanged randomly shuffled data sets at the first and second parties respectively;
re-obfuscate the re-encrypted data sets using the respective re-obfuscating numbers at the first and second parties; and
exchange the re-obfuscated data sets between the first and second parties.

12. The system as claimed in claim 11, wherein the means for performing an exchange process are further arranged to,
generate respective temporary numbers at the first and second parties;
exchange the temporary numbers between the first and second parties;
encrypt the exchanged temporary numbers at the first and second parties respectively; and
wherein the re-obfuscation of the re-encrypted data sets is based on the encrypted temporary numbers and the respective obfuscating numbers of the first and second parties.

13. The system as claimed in claim 12, wherein the means for performing an audit trail check process are arranged to,
share respective encrypted common trail generators between the first and second parties;
share respective modulo function values based on the encrypted temporary numbers and the obfuscating numbers between the first and second parties;
compute respective re-obfuscated audit trail sets at the first and second parties based on the shared encrypted common trail generators and modulo function values; and
perform the respective audit trail checks at the first and second parties based on the re-obfuscated audit trail sets and the re-obfuscated data sets.

14. The system as claimed in claim 9, wherein the means for proceeding with performing a matching process is arranged to,
share the respective re-obfuscating numbers between the first and second parties;
verify the respective shared re-obfuscating numbers at the first and second parties respectively;
re-generate the other party's re-obfuscated data set at the first and second parties respectively based on the verified re-obfuscating numbers; and
determine the common records between the first and second party based on intersecting the re-generated re-obfuscated data set of the other party with the party's own re-obfuscated data set.

15. A computer readable data storage medium having stored thereon computer code means for instructing respective computer processors of a first party and a second party to execute a method of sharing data between the first and the second parties, the method comprising the steps of:
performing respective randomization processes on data sets of the first and second parties;
performing an exchange process between the first and second parties;
performing an audit trail check process at the first and second parties respectively; and
proceeding with performing a matching process at the first and second parties respectively only after a successful audit trail check by each party in the audit trail check process and the matching process is such that each party can determine whether the other party has provided a correct re-obfuscating number for determining common records between the first and second party.
